(19) United States
(12) Patent Application Publication
(10) Pub. No.: US 2003/0187848 A1
(43) Pub. Date: Oct. 2, 2003

(54) Method and apparatus for restricting access to a database according to user permissions

(76) Inventors: Hovhannes Ghukasyan, Mountain View, CA (US); Yervant D. Lepejian, Palo Alto, CA (US)

Correspondence Address: WILLIAM P. WILBAR, SIERRA PATENT GROUP, LTD., P.O. BOX 6149, STATELINE, NV, 89449, US

(21) Appl. No.: 10/115,196

(22) Filed: Apr. 2, 2002

(51) Int. Cl. G06F 7/00

(52) U.S. Cl. 707/9

(57) ABSTRACT

A method and apparatus for restricted access to a database according to user permissions are described. A user permissions file residing on a server includes information of permissions related to database records, and which of those permissions are associated with individual users. A permissions manager also residing on the server manages user queries either directly by generating restricted queries that reflect only authorized access to database records for the user generating the query, or indirectly by downloading a permissions filter or information for a restricted parameters screen to the user's client, so as to generate the restricted query on the client. In any case, a database management system residing on the server receives the restricted query and generates a result by accessing only authorized database records for the user, and communicates the result back to the user's client.

### FIELD OF THE INVENTION

The present invention generally relates to database records security and in particular, to a method and apparatus for restricting access to a database according to user permissions.

### BACKGROUND OF THE INVENTION

In a client-server system, client users may communicate with a server to access information stored in a database on the server. In these systems, database access is generally controlled by a database management system (“DBMS”) that is also on the server. FIG. 1 illustrates one such client-server system 100, wherein users of clients such as clients 102, 103 and 104 communicate with a server 101 over a local area network 105. FIG. 2 illustrates another such client-server system 200, wherein users of clients such as clients 202, 203 and 204 communicate with a server 201 through the Internet 205. Combinations of these and other such client-server systems are well known.

FIG. 3 illustrates a conventional DBMS 301 that receives a query 302 originating from a client user, retrieves information from a common database 304 in response to the query, and generates a result 303 from the retrieved information that is sent back to the client user. The query in this case is in typical SQL format:

SELECT <list of columns>
FROM <list of tables>
WHERE <conditions>.

Simple examples of tables included in the database 304 are shown in FIGS. 7˜9. In FIG. 7, the table is named PRODUCTION, because it provides manufacturing information for integrated circuit devices. A first column labeled DEVICE provides names of the integrated circuit devices DEVICE1, DEVICE2 and DEVICE3 for which information is being provided. A second column labeled WAFERCOUNT provides the number of wafers that were manufactured of each of the devices during a period of time associated with the table. A third column labeled YIELD provides the average yield of good die from all wafers manufactured of each of the devices during the period. In FIG. 8, the table is named LOTS, because it provides information of manufacturing lots fabricated during the period such as the specific device manufactured in each lot, the number of wafers manufactured in each lot, and the yield of good die from all wafers in the lot. In FIG. 9, the table is named WAFERS, because it provides yield information for each wafer produced during the period. In this last table, yield information is understood to be provided for all wafers, even though information for only the first and last wafer of each lot are shown to simplify the figure.

For security purposes, a client user having a proprietary interest in the integrated circuit device DEVICE1, for example, should not be able to gain access to information of other devices that he or she does not have a proprietary interest in. Likewise, other client users should not be able to gain access to information on the client user's integrated circuit device DEVICE1 if they are not authorized to do so.

Conventional database management systems, however, are not generally configured to restrict access to database records according to user permissions, but are generally configurable to restrict access at the table, view and column levels. Therefore, one way to provide record level control is to break up each table in a common database into multiple tables, wherein each of the multiple tables includes only records that are to be accessible to specific user or group of users. For example, each table in FIGS. 7˜9 may be broken up into smaller tables, wherein one table may be for information related only to DEVICE1, a second table may be for information related only to DEVICE2, and a third table may be for information related only to DEVICE3. The DBMS may then restrict access to each of the smaller tables so that only a client user who is authorized to access that table, because of a proprietary interest in the information stored in the table.

FIG. 4 illustrates one such technique for providing database records security. In this approach, the common database is broken up into several databases such as databases 404, 405 and 406, so that each database stores information that is only to be accessed by a corresponding client user or group of users. In particular, in this example, database 404 stores tables including only information related to DEVICE1, database 405 stores tables including only information related to DEVICE2, and database 406 stores tables including only information related to DEVICE3. Tables storing information common to all devices, are redundantly included in each of the databases 404˜406. After the client user has provided a user identification (USERID) and a database query (QUERY) in one or more communications 402 to a DBMS 401, the DBMS 401 retrieves information in response to the query from one of the databases 404˜406 that corresponds to the user identification (e.g., from database 404 for a query provided by a client user having proprietary interest in DEVICE1), and generates a result 403 that is communicated back to the client user.

FIG. 5 illustrates another such technique for providing database security. In this approach, the common database 504 includes sets of tables wherein each set includes information, for example, only for DEVICE1, DEVICE2 or DEVICE3. Access to each table is specified through grant statements stored in a file of table grant statements 505. A typical form of each grant statement is the conventional:

GRANT <specified privileges>
ON <table>
TO <user>.

The privileges that can be specified in this case include such actions as SELECT, DELETE, INSERT, and UPDATE information in the table. After the client user provides a user identification (USERID) and a query (QUERY) in one or more communications 502 to a DBMS 501, the DBMS 501 retrieves information in response to the query from one or more tables in the common database that the client user is authorized to SELECT according to information in the table grant statements 505, and generates a result 503 that is communicated back to the client user.

FIG. 6 illustrates still another such technique for providing database security. In this approach, multiple views are created as subsets of each of the tables in the database, wherein each view includes information, for example, only for DEVICE1, DEVICE2 or DEVICE3. In particular, for the PRODUCTION table of FIG. 7, three views are created:

CREATE VIEW PRODUCTION1 AS SELECT *

FROM PRODUCTION
WHERE DEVICE = ‘DEVICE1’;

CREATE VIEW PRODUCTION2 AS SELECT *

FROM PRODUCTION
WHERE DEVICE = ‘DEVICE2’; and

CREATE VIEW PRODUCTION3 AS SELECT *

FROM PRODUCTION
WHERE DEVICE = ‘DEVICE3’.

Privileges for each view is then set for each of the client users. After the client user provides a user identification (USERID) and a query (QUERY) in one or more communications 602 to a DBMS 601, the DBMS 601 retrieves information in response to the query from one or more views that the client user is authorized to access in a common database 604, and generates a result 603 that is communicated back to the client user. A views manager 605 utilizing the multiple views and view privileges previously described, controls the authorization in this case.

Although the methods and apparatuses described in reference to FIGS. 4˜6 provide database security, they have numerous problems. For example, they are cumbersome to implement, because of the large numbers of tables involved. Also, they are difficult to maintain, because of the large number of items to be updated as the amount of database information grows larger. Further, such techniques may fail their primary purpose of database security when a join graph automatically generated for a query includes additional tables that are not otherwise protected from unauthorized access by the user generating the query.

### OBJECTS AND SUMMARY OF THE INVENTION

Accordingly, it is an object of the present invention to provide a method for restricting access to a database according to user permissions, that is easy to implement and simple to maintain.

Another object is to provide an apparatus for restricting access to a database according to user permissions, that is easy to implement and simple to maintain.

Still other objects are to provide a method and an apparatus for restricting access to a database according to user permissions, that do not fail their primary purpose of database security as a result of the inclusion of additional tables not specified in the original query that are added through a join graph for the query.

These and additional objects are accomplished by the various aspects of the present invention, wherein briefly stated, one aspect is a method for restricting access to a database according to user permissions, comprising: receiving a user identification provided by a client user; receiving a query provided by the client user for a database; and generating a restricted query to be provided as input to a database management system for the database by adding one or more restrictions to the query according to permissions associated with the user identification so as to restrict access to the database.

Still another aspect is an apparatus for restricting access to a database according to user permissions, comprising a server computer configured to: receive a user identification from a client computer; receive a query from the client computer for a database; and generate a restricted query to be provided as input to a database management system for the database by adding one or more restrictions to the query according to permissions associated with the user identification so as to restrict access to the database.

Yet another aspect is an apparatus for restricting access to a database according to user permissions, comprising a server computer including: database management system for accessing a database in response to a restricted query; user permissions file including information associating users with database records accessible to those users; and permissions manager generating the restricted query according to the information included in the user permissions file in response to a query from an identified user, and providing the restricted query to the database management system.

Another aspect is a method for restricting access to a database according to user permissions, comprising: receiving a user identification provided by a user; generating a permissions filter from information associated with the user identification so as to generate a restricted query from a user query by adding restrictions according to permissions associated with the user to the user query; and providing the permissions filter for use by the user so as to receive the user query, generate the restricted query, and communicate the restricted query to a database management system.

Another aspect is an apparatus for restricting access to a database according to user permissions, comprising a server computer including a database and a database management system, the server computer configured to: receive a user identification associated with a user from a client computer; generate a permissions filter from information associated with the user identification so as to generate a restricted query from a user query by adding restrictions according to permissions associated with the user to the user query; and download the permissions filter to the client computer so as to receive the user query, generate the restricted query, and communicate the restricted query back to the database management system for accessing the database.

Another aspect is an apparatus for restricting access to a database according to user permissions, comprising a server computer including: database management system for accessing database records in response to a restricted query; and permissions manager generating a permissions filter from information associated with a user and indicating database records accessible to the user so as to generate the restricted query from a query of the user by adding restrictions according to the information, and downloading the permissions filter to a client computer for use by the user.

Still another aspect is a method for restricting access to a database according to user permissions, comprising: receiving a user identification provided by a user; generating information for a restricted parameters screen from information associated with the user identification so as to generate a restricted query through user selection of available options limited by tables, columns and records accessible to the user in a database; and providing the information for the restricted parameters screen so as to be made available to the user as part of an interface between the user and a database management system.

Another aspect is an apparatus for restricting access to a database according to user permissions, comprising a server computer including a database and a database management system, the server computer configured to: receive a user identification associated with a user from a client computer; generate information for a restricted parameters screen from information associated with the user identification so as to generate a restricted query through selection by a user of the client computer of available options limited by tables, columns and records accessible to the user in a database; and download the information for the restricted parameters screen to the client computer to be made available to the user as part of an interface between the user and the database management system.

Still another aspect is an apparatus for restricting access to a database according to user permissions, comprising a server computer including: database management system for accessing database records in response to a restricted database query; and permissions manager generating information for a restricted parameters screen from information associated with a user indicating database records accessible to the user so as to generate the restricted database query through selection by the user of available options limited by tables, columns and records accessible to the user, and downloading the information for the restricted parameters screen to a client computer for use by the user.

Another aspect is a method for restricting access to a database according to user permissions, comprising: receiving a user identification provided by a user of a client computer; receiving a database query including a SELECT clause, FROM clause, and WHERE clause provided by the user; and modifying the WHERE clause of the database query to include permissions associated with the user identification that restrict access by the user to only authorized database records in a database.

Another aspect is a method for restricting access to a database according to user permissions, comprising providing a computer executable program including program code for receiving a user identification provided by a user of a client computer; receiving a database query including a SELECT clause, FROM clause, and WHERE clause provided by the user; and modifying the WHERE clause of the database query to include permissions associated with the user identification that restrict access by the user to only authorized database records in a database.

Still another aspect is an apparatus for restricting access to a database according to user permissions, comprising a computer configured to: receive a user identification provided by a user of a client computer; receive a database query including a SELECT clause, FROM clause, and WHERE clause provided by the user; and modify the WHERE clause of the database query to include permissions associated with the user identification that restrict access by the user to only authorized database records in a database.

Another aspect is a method for restricting access to a database according to user permissions, comprising: generating information of permissions related to database records; and generating information of users and associated permissions from the information of permissions so that access to the database records is restricted according to the information of users and associated permissions.

Another aspect is a method for restricting access to a database according to user permissions, comprising providing a computer executable program including program code for facilitating generation of information of permissions related to database records, and generation of information of users and associated permissions from the information of permissions so that access to the database records is to be restricted according to the information of users and associated permissions.

Yet another aspect is an apparatus for restricting access to a database according to user permissions, comprising a computer configured to generate information of permissions related to database records, and information of users and associated permissions from the information of permissions so that access to the database records is to be restricted according to the information of users and associated permissions.

Additional objects, features and advantages of the various aspects of the invention will become apparent from the following description of its preferred embodiments, which description should be taken in conjunction with the accompanying drawings.

### BRIEF DESCRIPTION OF THE DRAWINGS

FIG. 1 illustrates, as an example, a client-server system connected through a local area network.

FIG. 2 illustrates, as an example, a client-server system connected through the Internet.

FIG. 3 illustrates, as an example, a conventional database management system residing on a server of a client-server system.

FIG. 4 illustrates, as an example, a conventional database security system employing multiple databases.

FIG. 5 illustrates, as an example, a conventional database security system employing table grant statements.

FIG. 6 illustrates, as an example, a conventional database security system employing views with associated view privileges.

FIGS. 7˜9 illustrate, as examples, simple tables included in a database.

FIG. 10 illustrates, as an example, a database security system for restricting access to database records according to user permissions, utilizing aspects of the present invention.

FIG. 11 illustrates, as an example, another database security system for restricting access to database records according to user permissions, utilizing aspects of the present invention.

FIG. 12 illustrates, as an example, still another database security system for restricting access to database records according to user permissions, utilizing aspects of the present invention.

FIG. 13 illustrates, as an example, information of record level permissions stored as conditions in SQL format, utilizing aspects of the present invention.

FIG. 14 illustrates, as an example, information of user and permission couples, utilizing aspects of the present invention.

FIG. 15 illustrates, as an example, a flow diagram of a method for restricting access to database records according to user permissions, utilizing aspects of the present invention.

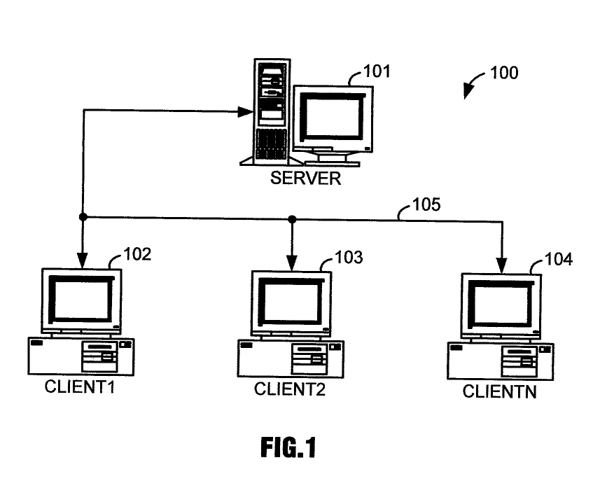

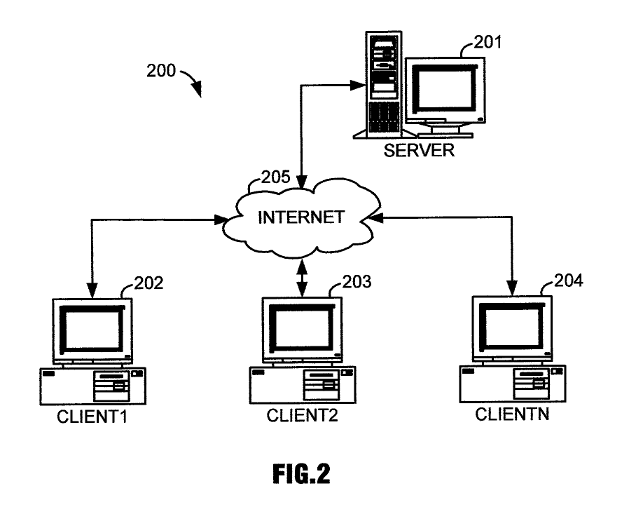

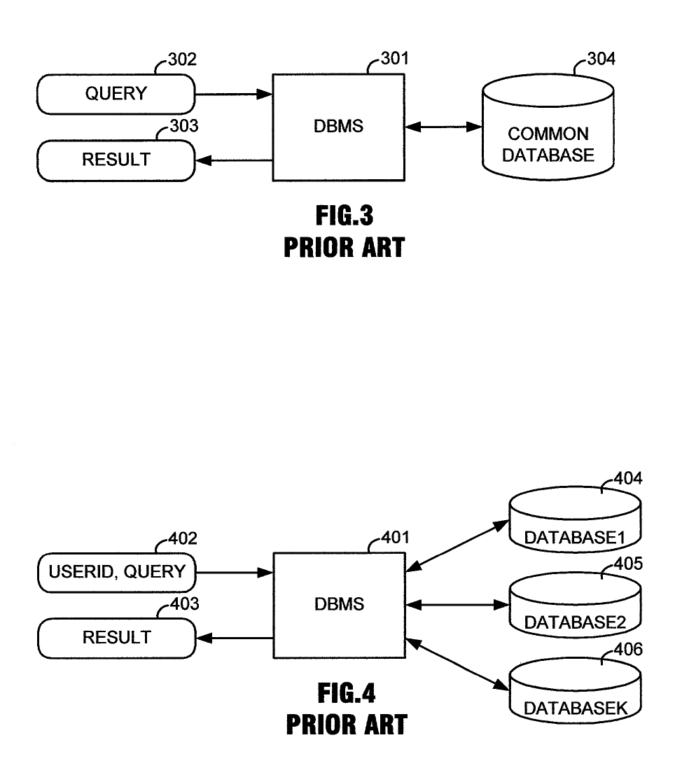

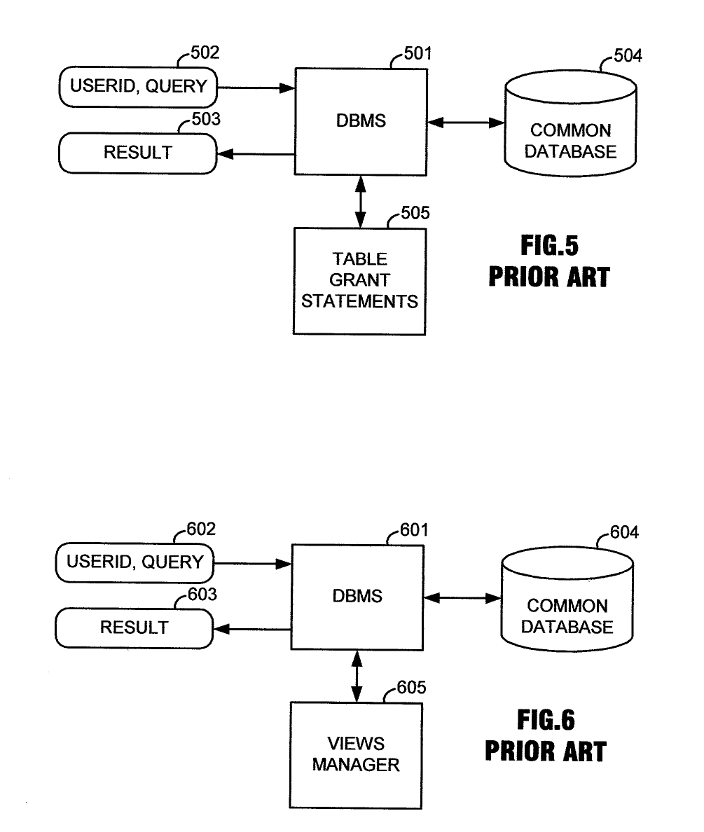

### DETAILED DESCRIPTIONS OF THE PREFERRED EMBODIMENTS

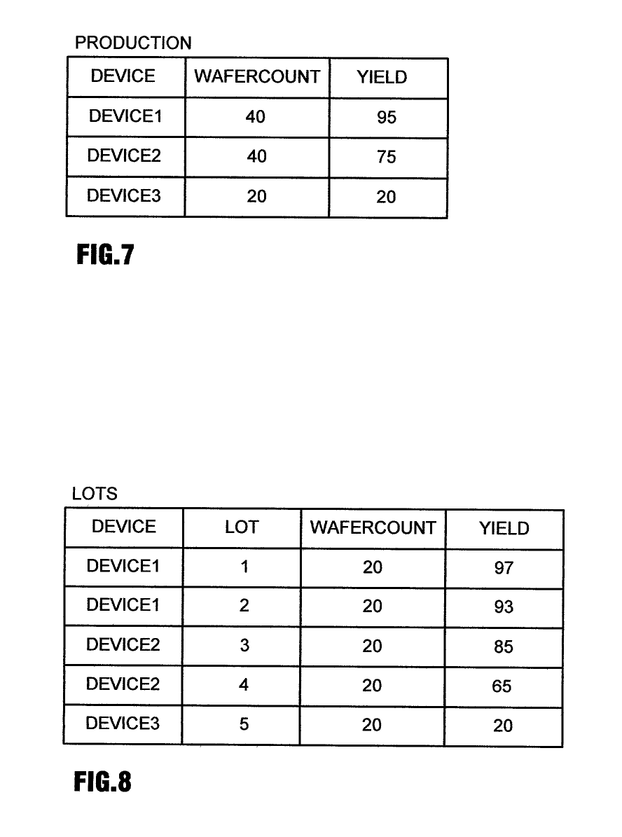

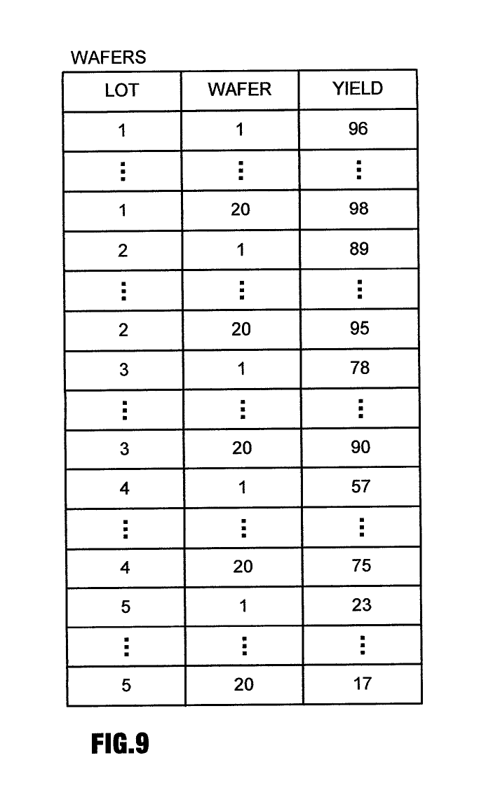

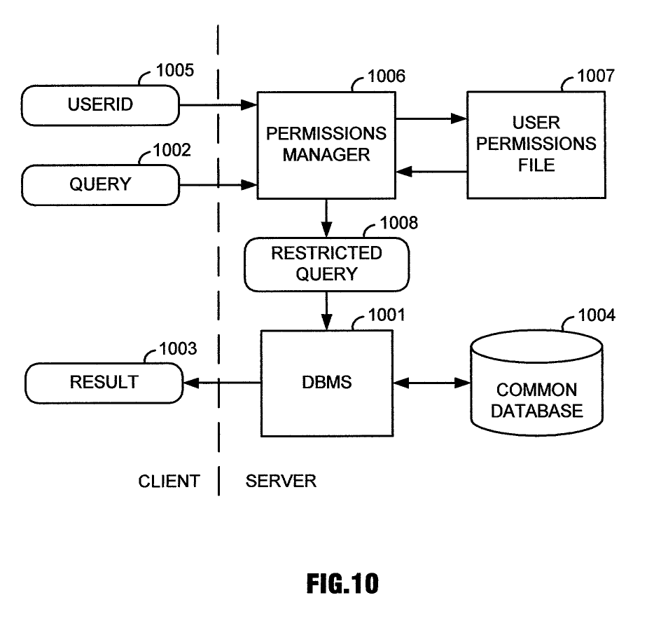

FIGS. 10˜12 illustrate, as examples of the present invention, database security systems that restrict access to database records according to user permissions. A significant distinguishing feature of these database security systems is that they control client user access to only authorized records of tables. Therefore, they do not require that tables such as the tables of FIGS. 7˜9 be broken up into smaller tables, so that each smaller table is accessible only by an authorized client user or related group of users. Therefore, less tables are required to implement the databases for these systems, less information redundancy is incurred, and their databases are easier to maintain than those of the conventional database security systems described in reference to FIGS. 4˜6.

In the database security system of FIG. 10, a permissions manager 1006 receives a user identification (USERID) 1005 originating from a client user that uniquely identifies the user as an individual or as one of a group of users. Typically, this USERID is provided by the client user when logging onto the database system. Subsequently, when the client user enters a database query, the query 1002 is received by the permissions manager 1006 either directly from the client user (such as shown in the figure), or indirectly through the DBMS 1001. In either case, the DBMS 1001 does not act upon the query 1002. The permissions manager 1006 then checks a user permissions file 1007 to determine which permissions are associated with the USERID and consequently, which database records the client user is authorized to access with regards to the query 1002, and generates a restricted query 1008 reflecting those database permissions. The restricted query 1008 is then provided to a DBMS 1001 that operates in a conventional fashion to retrieve information from a common database 1004, and generate a result 1003 that is passed back to the client user.

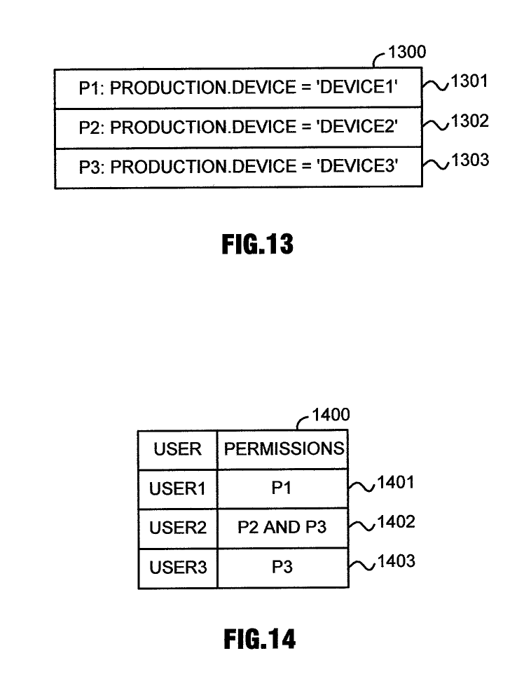

As an example of the user permissions file 1007, FIGS. 13 and 14 illustrate information included in the user permissions file 1007. The information is generated in this case by a database administrator through a computer program cooperating or integrated with the permissions manager 1006. Both the permissions manager 1006 and the computer program generating the permissions file 1007 are contemplated to be provided by software vendors through electronic transmission and/or on tangible media. FIG. 13 illustrates information 1300 including permissions 1301˜1303 stored as conditions in SQL format. Each permission in this case is related to at least one database record. FIG. 14 illustrates other information 1400 including couples 1401˜1403 of client users and associated permissions indicating which permissions of those included in information 1300 are associated with each client user. For example, since the client user USER1 is only authorized to read information related to device DEVICE1 in the PRODUCTION table of FIG. 7 according to user and permissions couple 1401 and its referenced permission 1301, then a query 1002 received from the client user such as:

SELECT DEVICE
FROM PRODUCTION
WHERE YIELD > 20,

will be modified by the permissions manager 1006 to include the additional restriction “AND PRODUCTION.DEVICE=DEVICE1” so that the restricted query 1008 in this case will be:

SELECT DEVICE
FROM PRODUCTION
WHERE YIELD > 20 AND PRODUCTION.DEVICE = DEVICE1”.

Preferably, the user permissions file 1007 is secured against unauthorized viewing and tampering. Conventional techniques, such as encryption, are used to secure the file so that it can only be modified by the database administrator or other authorized individuals, and only viewed or otherwise accessed by such parties and the permissions manager 1006.

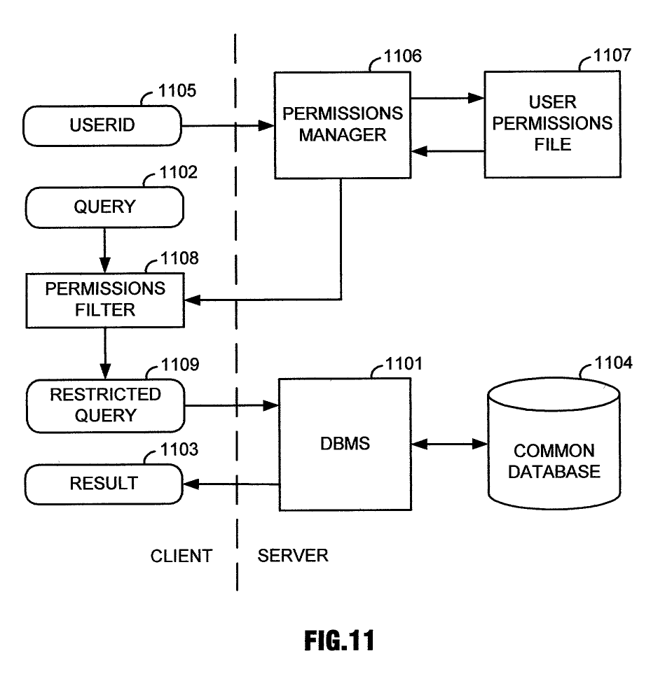

In the database security system of FIG. 11, a permissions manager 1106 receives a user identification (USERID) 1105 originating from a client user that uniquely identifies the user as an individual or as one of a group of users. As in the prior case, this USERID is typically provided by the client user when logging onto the database system. The permissions manager 1106 then checks a user permissions file 1107 to determine which database records the client user is authorized to access, and generates a permissions filter 1108 reflecting such database access permissions that is downloaded to the client. Preferably, the permissions filter 1108 is a tamper-proof software module. The user permissions file 1107 includes similar information such as stored in the user permissions file 1007 of FIG. 10, and it is similarly secured against unauthorized viewing and tampering. A standard user interface on the client is modified to cooperate with the permissions filter 1108 so that a client user query 1102 that is input to the user interface is modified by the permissions filter 1108 to generate a restricted query 1109. The restricted query 1109 is then provided to a DBMS 1101 that operates in a conventional fashion to retrieve information from a common database 1104, and generate a result 1103 that is passed back to the client user. The permissions filter 1108 in includes information of permissions that are coupled to the client user (such as permission 1301 that is coupled to USER1 according to user/permission couple 1401). The modified standard user interface then includes such information of permissions coupled to the client user as restrictions in the restricted query 1109.

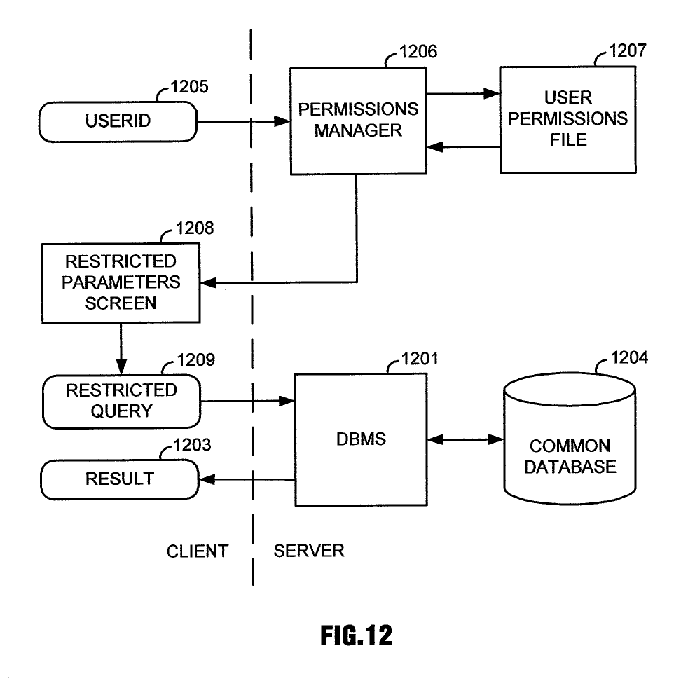

In the database security system of FIG. 12, a permissions manager 1206 receives a user identification (USERID) 1205 originating from a client user that uniquely identifies the user as an individual or as one of a group of users. As in the prior case, this USERID is typically provided by the client user when logging onto the database system. The permissions manager 1206 checks a user permissions file 1207 to determine which database records the client user is authorized to access, and then generates and transmits information to update a parameters screen 1208 displayed on the client screen through the client user interface to reflect those authorized permissions so that only tables, columns and records accessible to the client user are displayed for the user's selection. Preferably, transmission of the information to update the parameters screen 1208 is performed over a secure connection between the server and client computers. The user permissions file 1207 includes similar information such as stored in the user permissions file 1007 of FIG. 10, and it is similarly secured against unauthorized viewing and tampering. In this case, however, the client user query is limited to only authorized selections, so therefore, no modification of the query is necessary. Accordingly, a restricted query 1209 is automatically generated by the client user interface, and provided to a DBMS 1201. The DBMS 1201 then operates in a conventional fashion to retrieve information from a common database 1204 and generate a result 1203 that is passed back to the client user.

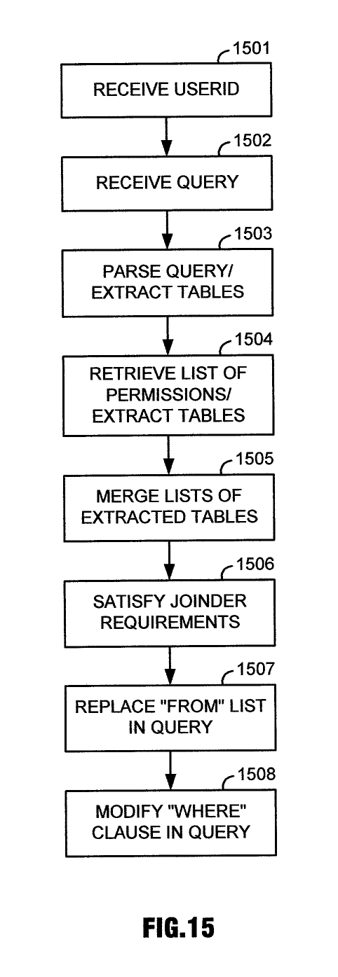

FIG. 15 illustrates, as an example, a flow diagram of a method for restricting access to database records according to user permissions. In 1501, a user identification (USERID) is received from a client user either directly through a network interface or indirectly through a database management system. The USERID is unique in this case for either the client user or a group of users that are subject to the same restrictions for accessing database records.

In 1502, a query is received from the client user either directly through the network interface or indirectly through the database management system. As an example, a client user, USER2, provides the following database query:

SELECT WAFERS.LOT, WAFERS.WAFER, WAFERS.YIELD;
FROM WAFERS;
WHERE WAFERS.LOT=’A’.

In 1503, the received query is parsed so as to extract a first list of tables involved in the query. Continuing with the example, the first list of tables in the above query is {WAFERS}.

In 1504, a list of permissions for the USERID is retrieved, and a second list of tables used in the permissions is extracted. Continuing with the example, the list of permissions for USER2 includes:

P2: PRODUCTTON.DEVICE=’DEVICE2’, and
P3: PRODUCTION.DEVICE=’DEVICE3’,

and the extracted second list of tables used in the permissions is {PRODUCTION}.

In 1505, the first and second lists of tables are merged to form a merged list of tables. Continuing with the example, the merged list of tables in this case is {WAFERS, PRODUCTION}.

In 1506, joining requirements for the merged list of tables are satisfied, resulting in a final list of tables including those necessary to complete a join graph including the merged list of tables. U.S. patent application Ser. No. 09/871,484 entitled “Automatic Generation of Join Graphs for Relational Database Queries,” filed May 31, 2001, assigned to the same assignee as the present application, and incorporated herein in its entirety by this reference, describes one method for performing this function. Now, continuing with the example, the join procedure adds the table LOTS, so that the final list of tables is {WAFERS, PRODUCTION, LOTS}. Additional join conditions necessary to complete the join graph include:

PRODUCTION.DEVICE=LOTS.DEVICE, and
LOTS.LOT=WAFERS.LOT.

In 1507, the final list of tables is used to replace the “FROM” list in the query. Continuing with the example, replacing the FROM clause in the original query results in the modified query:

SELECT WAFERS.LOT, WAFERS.WAFER, WAFERS.YIELD;
FROM WAFERS, PRODUCTION, LOTS;
WHERE WAFERS.LOT=’A’.

In 1508, the “WHERE” list of the query is modified to include any join conditions that are missing, but should be included. Also, additional restrictions are added to the “WHERE” list according to the permissions granted to the client user that restrict the user's access to records of the database. Again continuing with the example, adding the join conditions in the WHERE clause results in the modified query:

SELECT WAFERS.LOT, WAFERS.WAFER, WAFERS.YIELD;
FROM WAFERS, PRODUCTION, LOTS;
WHERE WAFERS.LOT=’A’

AND PRODUCTION.DEVICE=LOTS.DEVICE
AND LOTS.LOT=WAFERS.LOT.

Finally, adding the additional permissions restrictions in the WHERE clause results in the following restricted query:

SELECT WAFERS.LOT, WAFERS.WAFER, WAFERS.YIELD;
FROM WAFERS, PRODUCTION, LOTS;
WHERE WAFERS.LOT=’A’

AND PRODUCTION.DEVICE=LOTS.DEVICE
AND LOTS.LOT=WAFERS.LOT
AND (PRODUCTION DEVICE=’DEVICE2’ OR

PRODUCTION DEVICE=’DEVICE3’).

Although the various aspects of the present invention have been described with respect to a preferred embodiment, it will be understood that the invention is entitled to full protection within the full scope of the appended claims.

We claim:

1. A method for restricting access to a database according to user permissions, comprising:
receiving a user identification provided by a client user;
receiving a query provided by said client user for a database; and
generating a restricted query to be provided as input to a database management system for said database by adding one or more restrictions to said query according to permissions associated with said user identification so as to restrict access to said database.

2. The method according to claim 1, wherein said generating a restricted query, comprises retrieving information of said permissions associated with said user identification, and modifying said query by adding said one or more restrictions reflecting said permissions associated with said user identification to said query.

3. The method according to claim 2, wherein said query is in SQL format including a SELECT clause, a FROM clause, and a WHERE clause, and said modifying said query comprises adding said one or more restrictions reflecting said permissions associated with said user identification to said WHERE clause.

4. The method according to claim 2, wherein said query is in SQL format including a SELECT clause, a FROM clause, and a WHERE clause, and said modifying said query comprises modifying said FROM clause to include tables required by said permissions associated with said user identification.

5. The method according to claim 4, wherein said modifying said query further comprises modifying said WHERE clause to include join conditions resulting from including said tables required by said permissions associated with said user identification in said FROM clause.

6. An apparatus for restricting access to a database according to user permissions, comprising a server computer configured to:
receive a user identification from a client computer;
receive a query from said client computer for a database; and
generate a restricted query to be provided as input to a database management system for said database by adding one or more restrictions to said query according to permissions associated with said user identification so as to restrict access to said database.

7. The apparatus according to claim 6, wherein said server computer is configured to generate said restricted query by retrieving information of said permissions associated with said user identification, and modifying said query by adding said one or more restrictions reflecting said permissions to said query.

8. The apparatus according to claim 7, wherein said query is in SQL format including a SELECT clause, a FROM clause, and a WHERE clause, and said server computer is configured to modify said query by adding said one or more restrictions reflecting said permissions to said WHERE clause.

9. The apparatus according to claim 7, wherein said query is in SQL format including a SELECT clause, a FROM clause, and a WHERE clause, and said server computer is configured to modify said query by modifying said FROM clause to include tables required by said permissions associated with said user identification.

10. The apparatus according to claim 9, wherein said server computer is further configure to modify said query by modifying said WHERE clause to include join conditions resulting from including said tables required by said permissions associated with said user identification in said FROM clause.

11. An apparatus for restricting access to a database according to user permissions, comprising a server computer including:
database management system for accessing a database in response to a restricted query;
user permissions file including information associating users with database records accessible to those users; and
permissions manager generating said restricted query according to said information included in said user permissions file in response to a query from an identified user, and providing said restricted query to said database management system.

12. The apparatus according to claim 11, wherein said server computer is configured to receive a user identification and said query from a client computer operated by said identified user, and provide said user identification and said query to said permissions manager.

13. The apparatus according to claim 12, wherein said server computer and said client computer are coupled together in a server-client relationship.

14. The apparatus according to claim 13, wherein said query is in SQL format including a SELECT clause, a FROM clause, and a WHERE clause, and said server computer is configured to generate said restricted database query by modifying said WHERE clause according to said information included in said user permissions file.

15. The apparatus according to claim 11, wherein said permissions file is secured against unauthorized viewing and tampering.

16. A method for restricting access to a database according to user permissions, comprising:
receiving a user identification provided by a user;
generating a permissions filter from information associated with said user identification so as to generate a restricted query from a user query by adding restrictions according to permissions associated with said user to said user query; and
providing said permissions filter for use by said user so as to receive said user query, generate said restricted query, and communicate said restricted query to a database management system.

17. The method according to claim 16, wherein said receiving a user identification, comprising receiving said user identification from a client computer operated by said user.

18. The method according to claim 17, wherein said providing said permissions filter for use by said user, comprises downloading said permissions filter to said client computer so as to interact with a user interface on said client computer.

19. The method according to claim 17, wherein said database management system resides on a server computer, and said server computer and said client computer interact in a server-client relationship.

20. An apparatus for restricting access to a database according to user permissions, comprising a server computer including a database and a database management system, said server computer configured to:
receive a user identification associated with a user from a client computer;
generate a permissions filter from information associated with said user identification so as to generate a restricted query from a user query by adding restrictions according to permissions associated with said user to said user query; and
download said permissions filter to said client computer so as to receive said user query, generate said restricted query, and communicate said restricted query back to said database management system for accessing said database.

21. The apparatus according to claim 20, wherein said permissions filter comprises a tamper-proof software module.

22. The apparatus according to claim 20, wherein said permissions filter is configured to cooperate with a user interface program on said client computer so as to receive said user query, generate said restricted query, and communicate said restricted query back to said database management system for accessing said database.

23. An apparatus for restricting access to a database according to user permissions, comprising a server computer including:
database management system for accessing database records in response to a restricted query; and
permissions manager generating a permissions filter from information associated with a user indicating database records accessible to said user so as to generate said restricted query from a query of said user by adding restrictions according to said information, and downloading said permissions filter to a client computer for use by said user.

24. The apparatus according to claim 23, wherein said permissions filter comprises a tamper-proof software module.

25. The apparatus according to claim 23, wherein said permissions filter is configured to cooperate with a user interface program on said client computer so as to receive said user query, generate said restricted query, and communicate said restricted query back to said database management system for accessing said database.

26. A method for restricting access to a database according to user permissions, comprising:
receiving a user identification provided by a user;
generating information for a restricted parameters screen from information associated with said user identification so as to generate a restricted query through user selection of available options limited by tables, columns and records accessible to said user in a database; and
providing said information for said restricted parameters screen so as to be made available to said user as part of an interface between said user and a database management system.

27. The method according to claim 26, wherein said information for said restricted parameters screen comprises parameters information provided to said user interface so that said user interface displays said available options limited by tables, columns and records accessible to said user.

28. An apparatus for restricting access to a database according to user permissions, comprising a server computer including a database and a database management system, said server computer configured to:
receive a user identification associated with a user from a client computer;
generate information for a restricted parameters screen from information associated with said user identification so as to generate a restricted query through selection by a user of said client computer of available options limited by tables, columns and records accessible to said user in a database; and
download said information for said restricted parameters screen to said client computer to be made available to said user as part of an interface between said user and said database management system.

29. The apparatus according to claim 28, wherein said information for said restricted parameters screen comprises parameters information provided to a user interface on said client computer so that said user interface displays said available options limited by tables, columns and records accessible to said user on a display screen of said client computer.

30. The apparatus according to claim 29, wherein said server computer is further configured to download information for said restricted parameters screen to said client computer over a secure connection.

31. An apparatus for restricting access to a database according to user permissions, comprising a server computer including:
database management system for accessing database records in response to a restricted database query; and
permissions manager generating information for a restricted parameters screen from information associated with a user indicating database records accessible to said user so as to generate said restricted database query through selection by said user of available options limited by tables, columns and records accessible to said user, and downloading said information for said restricted parameters screen to a client computer for use by said user.

32. The apparatus according to claim 31, wherein said information for said restricted parameters screen comprises parameters information provided to a user interface on said client computer so that said user interface displays said available options limited by tables, columns and records accessible to said user on a display screen of said client computer.

33. The apparatus according to claim 32, wherein said server computer is further configured to download said information for said restricted parameters screen to said client computer over a secure connection.

34. A method for restricting access to a database according to user permissions, comprising:
receiving a user identification provided by a user of a client computer;
receiving a database query including a SELECT clause, FROM clause, and WHERE clause provided by said user; and
modifying said WHERE clause of said database query to include permissions associated with said user identification that restrict access by said user to only authorized database records in a database.

35. The method according to claim 34, further comprising:
extracting a first set of tables associated with said database query by parsing said database query;
extracting a second set of tables from said permissions associated with said user identification that restrict access by said user to only authorized database records in said database;
merging said first set of tables and said second set of tables to generate a merged set of tables;
determining additional tables as necessary for joining of said merged set of tables;
modifying said FROM clause to include said additional tables and said merged set of tables; and
modifying said WHERE clause to include additional join conditions as necessary for joining of said merged set of tables.

36. A method for restricting access to a database according to user permissions, comprising providing a computer executable program including program code for receiving a user identification provided by a user of a client computer; receiving a database query including a SELECT clause, FROM clause, and WHERE clause provided by said user; and modifying said WHERE clause of said database query to include permissions associated with said user identification that restrict access by said user to only authorized database records in a database.

37. The method according to claim 36, wherein said computer executable program further includes program code for extracting a first set of tables associated with said database query by parsing said database query; extracting a second set of tables from said permissions associated with said user identification that restrict access by said user to only authorized database records in said database; merging said first set of tables and said second set of tables to generate a merged set of tables; determining additional tables as necessary for joining of said merged set of tables; modifying said FROM clause to include said additional tables and said merged set of tables; and modifying said WHERE clause to include additional join conditions as necessary for joining of said merged set of tables.

38. An apparatus for restricting access to a database according to user permissions, comprising a computer configured to receive a user identification provided by a user of a client computer; receive a database query including a SELECT clause, FROM clause, and WHERE clause provided by said user; and modify said WHERE clause of said database query to include permissions associated with said user identification that restrict access by said user to only authorized database records in a database.

39. The apparatus according to claim 38, wherein said computer is further configured to: extract a first set of tables associated with said database query by parsing said database query; extract a second set of tables from said permissions associated with said user identification that restrict access by said user to only authorized database records in said database; merge said first set of tables and said second set of tables to generate a merged set of tables; determine additional tables as necessary for joining of said merged set of tables; modify said FROM clause to include said additional tables and said merged set of tables; and modify said WHERE clause to include additional join conditions as necessary for joining of said merged set of tables.

40. A method for restricting access to a database according to user permissions, comprising:
generating information of permissions related to database records; and
generating information of users and associated permissions from said information of permissions so that access to said database records is restricted according to said information of users and associated permissions.

41. A method for restricting access to a database according to user permissions, comprising providing a computer executable program including program code for facilitating generation of information of permissions related to database records, and generation of information of users and associated permissions from said information of permissions so that access to said database records is to be restricted according to said information of users and associated permissions.

42. An apparatus for restricting access to a database according to user permissions, comprising a computer configured to generate information of permissions related to database records, and information of users and associated permissions from said information of permissions so that access to said database records is to be restricted according to said information of users and associated permissions.
